(19) United States
(12) Patent Application Publication
(10) Pub. No.: US 2007/0247002 A1
(43) Pub. Date: Oct. 25, 2007

(54) WHEEL WITH MECHANICALLY BONDED RIM FOR TRACKED VEHICLES

(76) Inventors: Todd M. Huntimer, Arlington, SD (US); Daniel B. Palli, Nunda, SD (US)

Correspondence Address: BLACK LOWE & GRAHAM, PLLC, 701 FIFTH AVENUE, SUITE 4800, SEATTLE, WA, 98104, US

(21) Appl. No.: 11/379,281

(22) Filed: Apr. 19, 2006

(51) Int. Cl. B62D 55/14

(52) U.S. Cl. 305/136

(57) ABSTRACT

An endless track drive system includes a track and multiple shafts bearing outer flanges integrally secured proximate first and second ends of the shaft and a middle flange integrally secured to the shaft between the first and second outer flanges. A central wheel secures to the middle flange and engages the track. The central wheel is formed of first and second semi-circular sections combinable to form a circle. Each half section includes a rim made of polyurethane, or like polymer and a hub made of an ultra-high molecular weight (UHMW) polymer. The hub bears a plurality of projections extending radially outwardly and having a proximal portion secured to the hub and a distal portion forming an outermost portion of the hub. The distal portions are substantially larger in the circumferential direction than the proximal portion. The rim is molded around the plurality of projections.

### FIELD OF THE INVENTION

This invention relates generally to endless track drive systems and, more specifically, to methods for constructing drive and traction wheels for rubber track skid steer vehicles.

### BACKGROUND OF THE INVENTION

Small skid steer vehicles 10, such as that shown in FIG. 1, often have an endless track drive system including a rubber track 12 with a number of shafts bearing traction and drive wheels 14 with high friction rims to support and drive the track 12, respectively. One common manner of construction is to bond a rim formed of polystyrene-butadiene polymer to a hub made of an ultra-high molecular weight (UHMW) polymer. Polystyrene-butadiene bonds readily to UHMW polymers as compared to other polymers. However, polystyrene-butadiene wears away much more rapidly than other polymers.

In prior systems, the chemical bond between the polystyrene-butadiene and the hub was essential because of the manner of securing wheels to shafts in the endless track system. As shown in FIG. 2, a typical shaft 16 includes three or more flanges 18a-18c. A drive wheel, or traction wheel, secures to each of the flanges 18a-18c. Inasmuch as the flanges 18a-18c are typically welded to the shaft 16, the middle wheel 20 must be divided into sections 22a, 22b in order to be positioned around the shaft 16 to which the flanges 18a-18c secure.

The rims 24 of the sections 22a, 22b are much more prone to separate from the hubs 26 inasmuch as the elasticity of the rims 24 does not maintain them in place as would a rim formed as a complete circle. A strong chemical bond between the rims 24 and hubs 26 is therefore important in prior wheels to avoid separation. Even in applications with a rim formed in a complete circle, durability issues remain. The rubber compounds commonly used do not wear well when subjected to the harsh environments encountered by the tracked vehicles. The rim constantly rolls against the track with rocks, dirt, sand, vegetation, and other debris grinding between it and the track.

In view of the foregoing, it would be an advancement in the art to provide a rim 24 formed of much more durable material secured to a UHMW hub with decreased risk of separation.

### SUMMARY OF THE INVENTION

A wheel includes a hub bearing a plurality of projections extending radially outwardly and having a proximal portion secured to the hub and a distal portion forming an outermost portion of the hub. The distal portions are substantially larger in the circumferential direction than the proximal portion. A rim is molded around the plurality of projections in order to retain the rim. The projections extend substantially entirely across the hub substantially parallel to the axis of symmetry. The space between the projections may have various shapes including a dove tail shape and a tear drop shape. In some embodiments, the plurality of projections further include a groove extending into the plurality of projections parallel to the axis of symmetry. In some embodiments, the hub is formed of UHMW and the rim is formed of polyurethane.

The wheel may be used in an endless track drive system including a track supported by multiple shafts bearing drive wheels and traction wheels. The shafts bear outer flanges integrally secured proximate first and second ends of the shaft and a middle flange integrally secured to the shaft between the first and second outer flanges. The wheel secures to the middle flange and engages the track. In one embodiment, the wheel is formed of first and second semi-circular sections, the first and second sections are combinable to form a complete wheel that may be secured to a flange in a mid-portion of an axle.

A method of forming a wheel for an endless track system is also disclosed. First and second hub sections are formed. The sections are combinable to form a circular wheel. A plurality of projections extends radially outward from the hub sections. The projections have outermost portions larger than proximal portions. Rim sections are molded onto the projections. The hub sections are mounted to a flange.

### BRIEF DESCRIPTION OF THE DRAWINGS

Preferred and alternative embodiments of the present invention are described in detail below with reference to the following drawings.

FIG. 1 is a perspective view of a skid steer vehicle suitable for implementing the present invention;

FIG. 2 is a perspective view of a shaft and mounting flanges bearing a sectional wheel, in accordance with an embodiment of the present invention;

FIG. 3 is a perspective view of a flange bearing one section of a sectional wheel, in accordance with an embodiment of the present invention;

FIG. 4 is a cutaway perspective view of a portion of a hub bearing bonding projections, in accordance with an embodiment of the present invention;

FIG. 5 is a side cross sectional view of a portion of a hub bearing bonding projections, in accordance with an embodiment of the present invention; and

FIG. 6 is a front cross sectional view of an alternative embodiment of a hub bearing bonding projections, in accordance with an embodiment of the present invention.

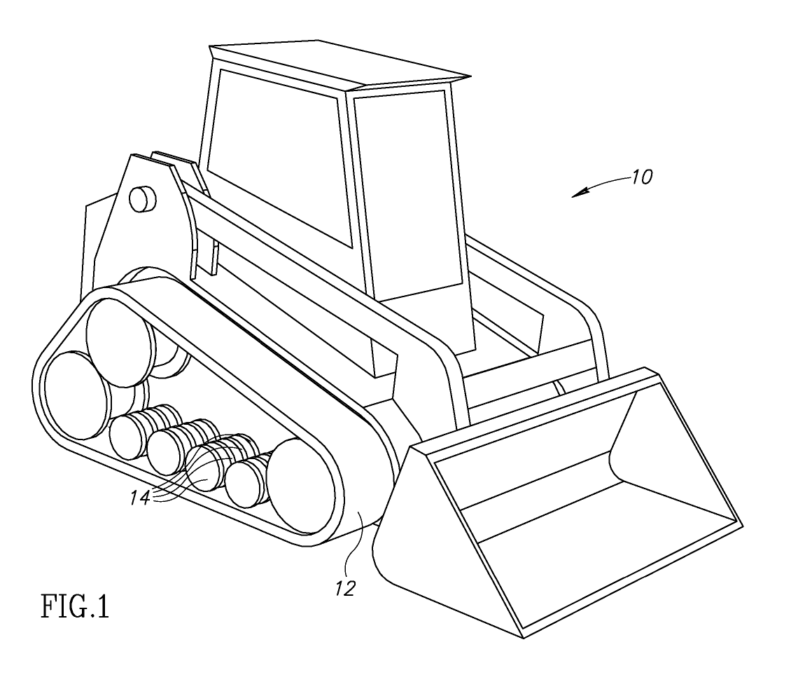

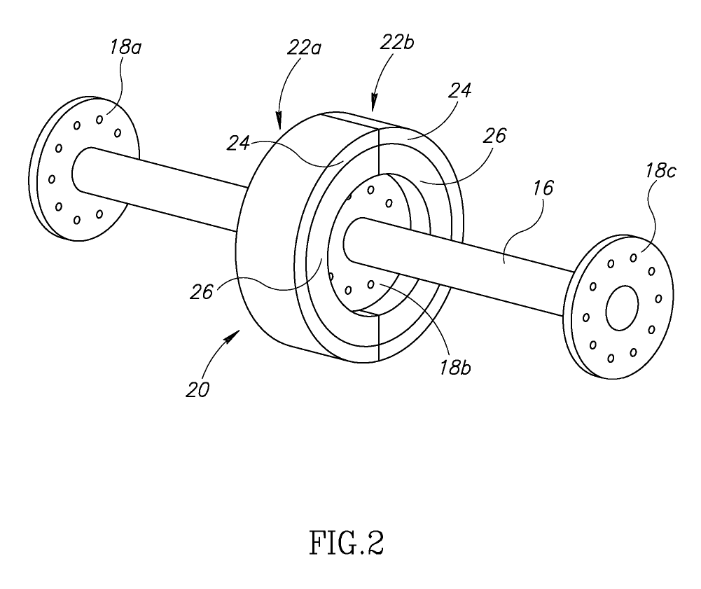

### DETAILED DESCRIPTION OF THE PREFERRED EMBODIMENT

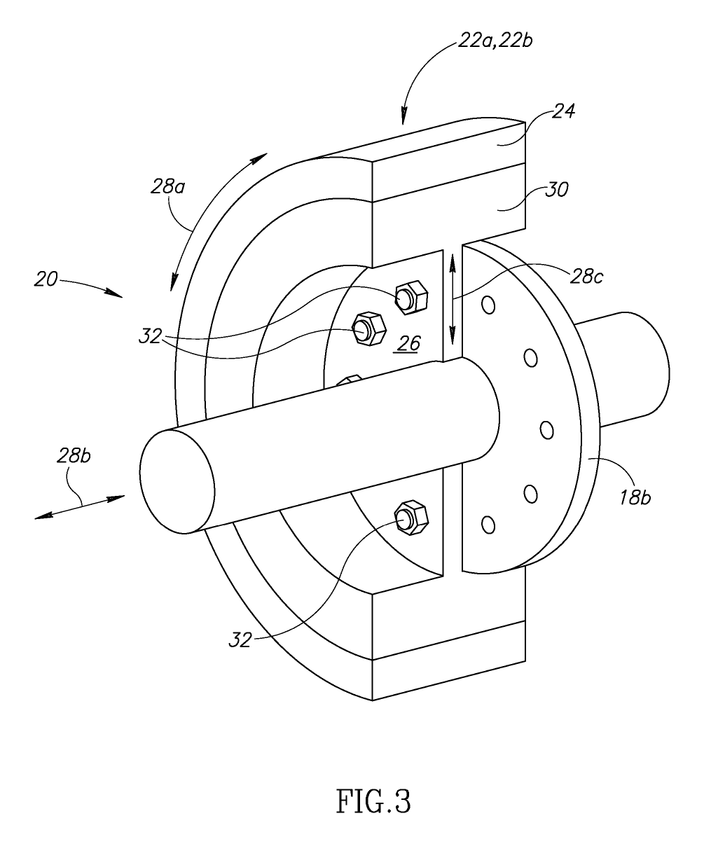

Referring to FIG. 3, a central wheel 20 formed in accordance with the present invention includes sections 22a, 22b having a rim 24 and a hub 26. The wheel 20 further defines a circumferential direction 28a corresponding to the circumference of the wheel, an axis of symmetry 28b, and a radial direction 28c extending perpendicular to the axis of symmetry 28b. The hub 26 includes a mounting flange 30 providing a wide surface for securing the rim 24 to the hub 26. Bolts 32 passing through the hub 26 and flange 18b secure the hubs 26 to the flange 18b.

Other mounting systems are also possible, for example, the wheel 20 may mount directly to the shaft 16 by means of set screws or the like. The shaft 16 may also be splined to constrain the wheel 20 to rotate with the shaft 16. The sections 22a, 22b may also have various embodiments. For example, the sections 22a, 22b may be of unequal sizes. One section 22a, 22b may be no larger than necessary to enable a shaft 16 to insert into the other section 22a, 22b.

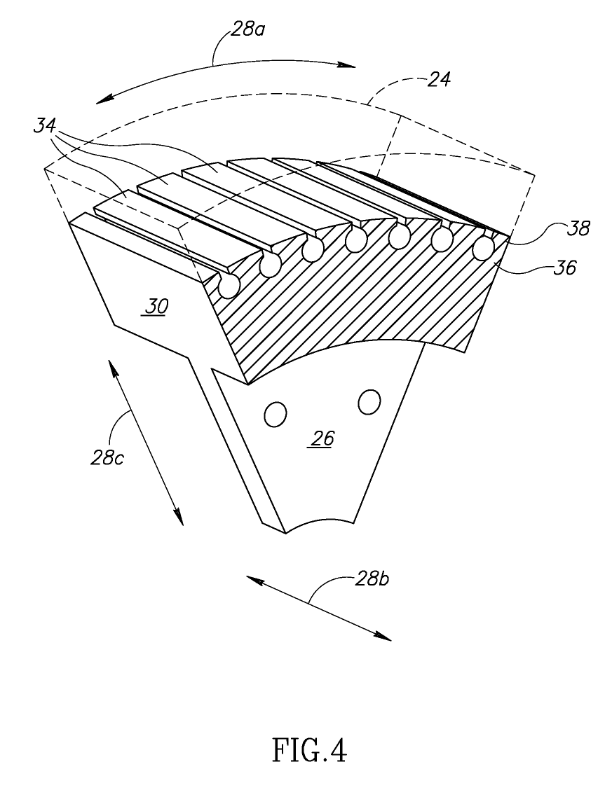

Referring to FIG. 4, a plurality of projections 34 are formed on the mounting flanges 30. The projections 34 each include a proximal portion 36 and a distal portion 38. The distal portion 38 is larger in the circumferential direction 28a than the proximal portion 36. In the illustrated embodiment, the projections 34 extend parallel to the axis of symmetry 28b across substantially the entire width of the mounting flanges 30. The gap between the projections 34 is tear-drop shaped in the illustrated embodiment. The rim 24 is molded around the projections 34. In one embodiment, the hub is first formed using injection molding, machining, or like means. The hub is then placed in an injection mold and the rim is injected between the mold and the outer portion of the hub 26 around the projections 34 and allowed to cool and/or cure, depending on the type of polymer used.

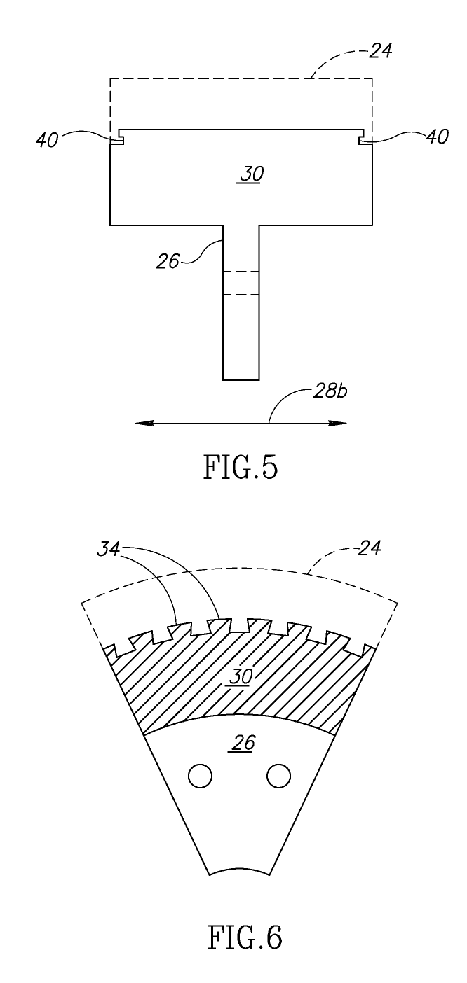

Referring to FIG. 5, grooves 40 may be formed in the projections 34 such that the rim 24 is further mechanically restrained. Referring to FIG. 6, various shapes and sizes of projections 34 may be used. For example, the projections 34 may define a dovetail shaped gap therebetween.

Materials used for the rim 24 may include polyurethane or like polymers. The hub 26 may therefore also be formed of any material offering sufficient structural strength including ultra-high molecular weight (UHMW) polymers, other rigid polymers, and metals. The materials used need not be limited to those capable of chemically bonding with one another. However, in some embodiments, a chemical bond may be encouraged by using carbon black in both hub polymer and rim polymer.

It is apparent that the novel wheel disclosed herein enables the use of a wider range of materials than is possible in prior wheels. Wheels constructed in the novel manner described above have been shown to have a useful life 55 times longer than prior wheels. The benefits of the novel wheel disclosed is not limited to wheels formed in sections, but rather may be used to increase the useful life of both traction and drive wheels secured to any of the flanges 18a-18c of a shaft 16, or to another component of an endless track drive system.

While the preferred embodiments of the invention have been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A wheel for use in an endless track drive having a circumferential direction, a radial direction, and an axis of symmetry, the wheel comprising:
a rim including a polymer; and
a hub including a rigid material, the hub bearing a plurality of projections extending in the radial direction outwardly and having a distal portion forming an outermost portion of the hub and a proximal portion, the distal portion being substantially larger in the circumferential direction than the proximal portion, the rim being molded around the plurality of projections.

3. The wheel of claim 1, wherein the rim includes polyurethane and wherein the hub includes an ultra-high molecular weight (UHMW) polymer.

4. The wheel of claim 1, wherein the projections extend substantially entirely across the hub substantially parallel to the axis of symmetry.

5. The wheel of claim 1, wherein the adjacent projections of the plurality of projections define a dovetail cavity therebetween.

6. The wheel of claim 1, wherein adjacent projections of the plurality of projections define a tear-drop shape therebetween.

7. The endless track of claim 1, wherein the plurality of projections further include a groove extending into the plurality of projections parallel to the axis of symmetry.

8. A wheel comprising:
first and second half sections, the first and second half sections combinable to form a circle having a circumferential direction, a radial direction, and an axis of symmetry, each half section including a rim including polyurethane and a hub bearing a plurality of projections extending radially outwardly and having a distal portion forming an outermost portion of the hub and a proximal portion, the distal portion being substantially larger in the circumferential direction than the proximal portion, the rim being molded around the plurality of projections.

9. The wheel of claim 8, wherein the rim includes polyurethane and wherein the hub includes an ultra-high molecular weight (UHMW) polymer.

10. The wheel of claim 8, wherein the projections extend substantially entirely across the hub substantially parallel to the axis of symmetry.

11. The wheel of claim 8, wherein the adjacent projections of the plurality of projections define a dovetail cavity therebetween.

12. The wheel of claim 8, wherein adjacent projections of the plurality of projections define a tear-drop shape therebetween.

13. The wheel of claim 8, wherein the plurality of projections further include a groove extending into the plurality of projections parallel to the axis of symmetry.

14. An endless track drive system comprising:
a track;
a shaft comprising first and second outer flanges integrally secured proximate first and second ends of the shaft and a middle flange integrally secured to the shaft between the first and second outer flanges; and
a central wheel secured to the middle flange and engaging the track, the central wheel comprising first and second half sections, the first and second half sections combinable to form a circle having a circumferential direction, a radial direction, and an axis of symmetry, each half section including a rim including polyurethane and a hub including an ultra-high molecular weight (UHMW) polymer, the hub bearing a plurality of projections extending radially outwardly and having a distal portion forming an outermost portion of the hub and a proximal portion, the distal portion being substantially larger in the circumferential direction than the proximal portion, the rim being molded around the plurality of projections.

15. The endless track of claim 14, wherein the projections extend substantially entirely across the hub substantially parallel to the axis of symmetry.

16. The endless track of claim 14, wherein the adjacent projections of the plurality of projections define a dovetail cavity therebetween.

17. The endless track of claim 14, wherein adjacent projections of the plurality of projections define a tear-drop shape therebetween.

18. The endless track of claim 14, wherein the plurality of projections further include a groove extending into the plurality of projections parallel to the axis of symmetry.

19. A method for forming a wheel comprising:
forming first and second hub sections, the first and second hub sections combinable to form a circle having a circumferential direction, a radial direction, and an axis of symmetry, the first and second hub sections bearing a plurality of projections extending radially outwardly and having a distal portion forming an outermost portion of the hub and a proximal portion, the distal portion being substantially larger in the circumferential direction than the proximal portion,
molding first and second rim sections around the plurality of projections of the first and second hub sections, respectively; and
securing the first and second hub sections to one another to form a wheel.

20. The method of claim 19, wherein securing the first and second hub sections to one another comprises securing the first and second hub sections to a flange mounted to a shaft.

21. The method of claim 19, wherein the first and second rim sections include polyethylene and the hub sections include an ultra-high molecular weight (UHMW) polymer.
